(19) United States
(12) Patent Application Publication
(10) Pub. No.: US 2005/0155582 A1
(43) Pub. Date: Jul. 21, 2005

(54) Fuel supply system for an internal combustion engine

(76) Inventors: Peter Schelhas, Stuttgart (DE); Thomas Frenz, Noerdlingen (DE); Andreas Posselt, Muehlacker (DE); Andreas Herforth, Leonberg (DE)

Correspondence Address: KENYON & KENYON, ONE BROADWAY, NEW YORK, NY, 10004, US

(21) Appl. No.: 11/008,380

(22) Filed: Dec. 8, 2004

(30) Foreign Application Priority Data
Jan. 15, 2004 (DE) 10 2004 002 139.2

(51) Int. Cl. F02M 37/04

(52) U.S. Cl. 123/497

(57) ABSTRACT

A fuel supply system (2) for an internal combustion engine (1) for, in particular, a motor vehicle. The fuel supply system (2) is used for delivering fuel from a fuel tank (3) into at least one intake manifold (4) or at least one combustion chamber (5) of the internal combustion engine (1) and includes at least two fuel pumps (6, 8; 11) connected in series. In order to ensure that the internal combustion engine (1) is supplied with fuel at any operating point of the internal combustion engine (1), it is provided that at least two of the fuel pumps (6, 8; 11) of the fuel supply system (2) take the form of electric fuel pumps (6, 8). The second electric fuel pump (8) in the direction of flow is preferably adjusted to a separate, variable pressure level in a demand-responsive manner, so that the pressure and fuel quantity are controlled.

### FIELD OF THE INVENTION

The invention relates to a fuel supply system for an internal combustion engine of, in particular, a motor vehicle. The fuel supply system is used for delivering fuel from a fuel tank into at least one intake manifold or at least one combustion chamber of the internal combustion engine. The fuel supply system includes at least two fuel pumps connected in series.

The invention also relates to an internal combustion engine for, in particular, a motor vehicle. The internal combustion engine includes a fuel supply system for delivering fuel from a fuel tank into at least one intake manifold or at least one combustion chamber of the internal combustion engine. The fuel supply system includes at least two fuel pumps connected in series.

### DESCRIPTION OF RELATED ART

Fuel supply systems of the type mentioned at the outset are known from the related art. Using such a fuel supply system, fuel can either be injected into an intake manifold of an internal combustion engine (so-called manifold injection) or directly injected into the combustion chambers of the internal combustion engine (so-called direct injection). Using the fuel pumps situated in the fuel supply system, fuel is drawn out of a tank and transported in the direction of the internal combustion engine.

A fuel supply system for a manifold injection system normally has a fuel pump taking the form of an electric fuel pump. The electric fuel pump may be combined with a fuel filter to form a module to be built into the fuel tank. The electric fuel pump normally has an electronic demand-control unit in the low-pressure circuit, i.e. on the suction side. Pressures of, for example, 3 to 6 bar can be generated with the aid of the electric fuel pump.

Fuel supply systems are known for direct-injection gasoline engines, those fuel supply systems having, in addition to the electric fuel pump functioning as a presupply pump, at least one further fuel pump which is connected in series with the electric fuel pump and takes the form of a high-pressure fuel pump. The high-pressure fuel pump is preferably mechanically driven by the internal combustion engine, via a camshaft or the like. In the case of direct-injection gasoline engines, the high-pressure fuel pump can increase the relatively low pressures generated by the electric fuel pump to, e.g. 120 to 150 bar, and, in the case of direct-injection diesel engines, to approximately 1,300 to 1,500 bar.

In the known fuel supply systems for a manifold injection system, the electric fuel pump is used as the sole fuel pump by which the injection pressure is generated. However, in fuel supply systems for direct injection, the electric fuel pump is only used as a presupply pump. The actual injection pressure is generated by the high-pressure pump situated downstream in the direction of flow.

In operating phases of the internal combustion engine, during which there is an increased demand for fuel, in particular when operating the internal combustion engine in the part-throttle and full-throttle ranges, known fuel supply systems have the problem that it is impossible to adjust, or to adequately adjust, the quantity [flow rate] and pressure of the electric fuel pump. Thus, it cannot always be ensured that the internal combustion engine is reliably powered in these operating phases.

### SUMMARY OF THE INVENTION

Therefore, the object of the present invention is to supply fuel to an internal combustion engine in an improved manner, in particular in operating phases of the internal combustion engine in which the fuel-quantity demand is increased.

To achieve this object, the invention provides that, starting out from the fuel supply system of the species mentioned at the outset, at least two of the fuel pumps of the fuel supply system take the form of electric fuel pumps.

Thus, the present invention provides for the one electric fuel pump normally used in fuel supply systems of the related art to be replaced by at least two electric fuel pumps, which are connected in series and take the form of separate pump stages. This allows the pressure and quantities [flow rates] of the second and any subsequent electric fuel pumps in the direction of flow to be adjusted to a separate, variable pressure level, in a demand-responsive manner. An important advantage of the fuel supply system is also that, with the aid of the second and all post-connected electric fuel pumps, the attainable pressure level may be increased and flexibly adjusted to any values within a specifiable pressure range. In addition, continuous fuel-quantity [flow-rate] and pressure adjustment may be carried out when operating the internal combustion engine in the part-throttle and full-throttle ranges.

The fuel supply system of the present invention provides that, in addition to a conventional electric fuel pump, at least one further electric fuel pump be positioned downstream from it in a fuel path from a fuel tank to the internal combustion engine. This additional electric fuel pump allows the fuel pressure of, e.g. approximately 2.5 to 5 bar on the pressure side of the first electric fuel pump to be increased to approximately 8 to 15 bar on the pressure side of the second electric fuel pump. The second and each post-connected electric fuel pump may be activated during specific engine operating phases, in which the fuel-quantity demand is increased. For example, in addition to the first electric fuel pump, the further electric fuel pumps may be activated during a starting phase of the internal combustion engine, especially in the case of a cold start. However, the second and any downstream electric fuel pump may also be switched on when the engine is operated in the full-throttle range, in order to reach the increased operating pressure on the pressure side of the second electric fuel pump from the normal pressure level in the fuel supply system on the pressure side of the first electric fuel pump. Using the second and any post-connected electric fuel pump, the delivered amount of fuel and the attainable fuel pressure may be controlled in a demand-responsive manner, when the first electric fuel pump delivers the maximum amount of fuel at a predetermined pressure while being operated at full power.

Of course, the fuel supply system of the present invention may be used for both internal combustion engines having a manifold injection system and for direct-injection gasoline engines. For use in direct-injection engines, the fuel supply system has at least one mechanically driven, high-pressure pump situated hydraulically nearer to the internal combustion engine than the electric fuel pumps. For use in internal combustion engines having manifold injection, all of the fuel pumps of the fuel supply system exclusively take the form of electric fuel pumps. In this instance, the presupply pumps would be implemented using several separate pump stages. The fuel supply system preferably has exactly two electric fuel pumps.

The demand-responsive control of the second and any further electric fuel pump may be implemented in different ways. In particular, it is conceivable for the fuel supply system to have control means for adjusting the pressure of the fuel delivered by the electric fuel pump situated hydraulically nearest to the internal combustion engine, to a specifiable pressure level. The specifiable pressure level is preferably variable.

The control means may take completely different forms. In particular, it is conceivable for the control means to be a control unit for switching on and off the electric fuel pump hydraulically nearest to the internal combustion engine, i.e. the second and/or any downstream electric fuel pump, or a control unit for varying the speed of this electric fuel pump.

It is also conceivable for the control means to have a controllable control element, which is situated in a return line from a pressure side of the electric fuel pump situated hydraulically nearest to the internal combustion engine, to the fuel tank, or to the suction side of this electric fuel pump. The control element is preferably electrically controllable, the control means then having a control unit for controlling the control element. The control element preferably takes the form of an electrically controllable pulse valve or an electrically controllable, proportional, fuel-quantity control valve.

Furthermore, it is provided that the control element take the form of a mechanical pressure regulator for adjusting the pressure prevailing on the pressure side of the electric fuel pump situated hydraulically nearest to the internal combustion engine, to the specifiable pressure level. In a further refinement of the present invention, each of the electric fuel pumps of the fuel supply system is assigned a mechanical pressure regulator, the pressure regulators each being situated in a return line from a pressure side of one of the electric fuel pumps to the fuel tank, or to the suction side of this electric fuel pump, and the pressure regulators adjusting the pressures prevailing on the pressure sides of the electric fuel pumps to different pressure levels. The different pressure levels preferably increase from the first electric fuel pump to the electric fuel pump positioned nearest to the internal combustion engine.

On the basis of the internal combustion engine of the species mentioned at the outset, it is provided that, as a further means for achieving the object of the present invention, the internal combustion engine have a fuel supply system of the present invention, including at least two electric fuel pumps connected in series.

### BRIEF DESCRIPTION OF THE DRAWINGS

Additional features, options for use, and advantages of the invention result from the subsequent description of exemplary embodiments of the invention represented in the drawings. All of the features described or illustrated here, either alone or in any desired combination, constitute the subject matter of the present invention, regardless of how they are combined in the patent claims or their antecedent references, and regardless of how they are defined in the description or illustrated in the drawings. The figures show:

FIG. 1 a schematic representation of a fuel supply system of the present invention, for an internal combustion engine having manifold injection;

FIG. 2 a schematic representation of a fuel supply system of the present invention, for an internal combustion engine having direct injection;

FIG. 3 a detailed representation of the fuel supply system of the present invention from FIG. 1, according to a first preferred embodiment;

FIG. 4 a detailed representation of the fuel supply system of the present invention from FIG. 1, according to a second preferred embodiment;

FIG. 5 a detailed representation of the fuel supply system of the present invention from FIG. 1, according to a third preferred embodiment;

FIG. 6 a detailed representation of the fuel supply system of the present invention from FIG. 1, according to a fourth preferred embodiment; and

FIG. 7 a preferred embodiment of a control strategy for the fuel supply system of the present invention.

### DETAILED DESCRIPTION OF THE INVENTION

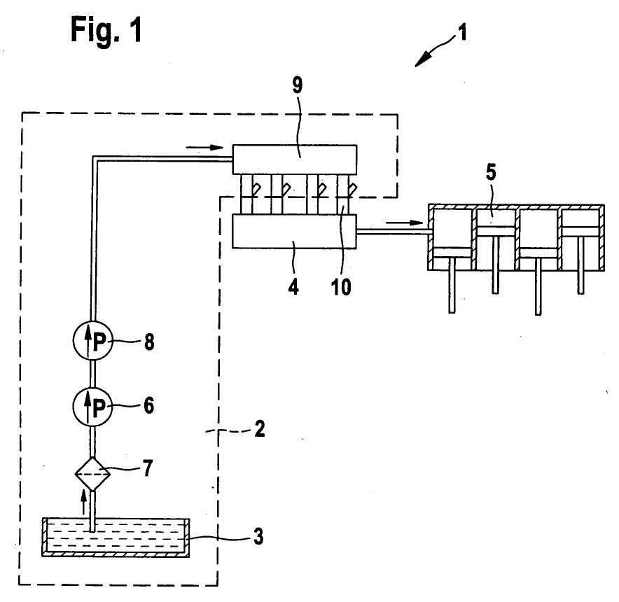

In FIG. 1, an internal combustion engine according to the invention is designated in its entirety by reference numeral 1. This includes a fuel supply system 2 for delivering fuel from a fuel tank 3 into an intake manifold 4 of the internal combustion engine 1. From there, the fuel travels into combustion chambers 5 of internal combustion engine 1.

Fuel supply system 2 includes a first electric fuel pump 6, which pumps fuel out of fuel tank 3 and through a fuel filter 7. Situated downstream from first electric fuel pump 6 in the direction of flow is an additional electric fuel pump 8, which further transports the fuel pumped by first electric fuel pump 6, into a fuel reservoir 9, from where the fuel travels through at least one injection valve or at least one injection nozzle 10 into the intake manifold 4.

First electric fuel pump 6 produces a pressure of approximately 2.5 to 6 bar on the pressure side. Second electric fuel pump 8 increases this pressure to an operating pressure in the range of approximately 8 to 15 bar. This operating pressure is applied to the pressure side of second electric fuel pump 8, i.e. in fuel reservoir 9, for example.

The two electric fuel pumps 6, 8 connected in series function as separate pump stages. Instead of only two pumps, several electric fuel pumps may also be connected in series. The advantage of connecting several electric fuel pumps in series is that the second and all subsequent electric fuel pumps 8, but at least last fuel pump 8 in the direction of flow, may be adjusted to a separate, variable pressure level (the operating pressure) in a demand-responsive manner, so as to control pressure and fuel quantity. The amount of fuel and the fuel pressure are controlled in a demand-responsive manner, with the aid of second electric fuel pump 8, when first electric fuel pump 6 delivers the maximum amount of fuel at full power, given a specified pressure. The increased pressure level (the operating pressure) may be flexibly adjusted to any values within a specifiable range. Different options for controlling the operating pressure are discussed further below.

During specific operating phases or under specific operating conditions of internal combustion engine 1, e.g. during a starting phase of internal combustion engine 1, in particular during a cold start phase, or during part-throttle operation or full-throttle operation of internal combustion engine 1, second and any other electric fuel pump 8 may be selectively switched on. In this manner, fuel amounts and pressures may be continuously adjusted at any operating points of internal combustion engine 1.

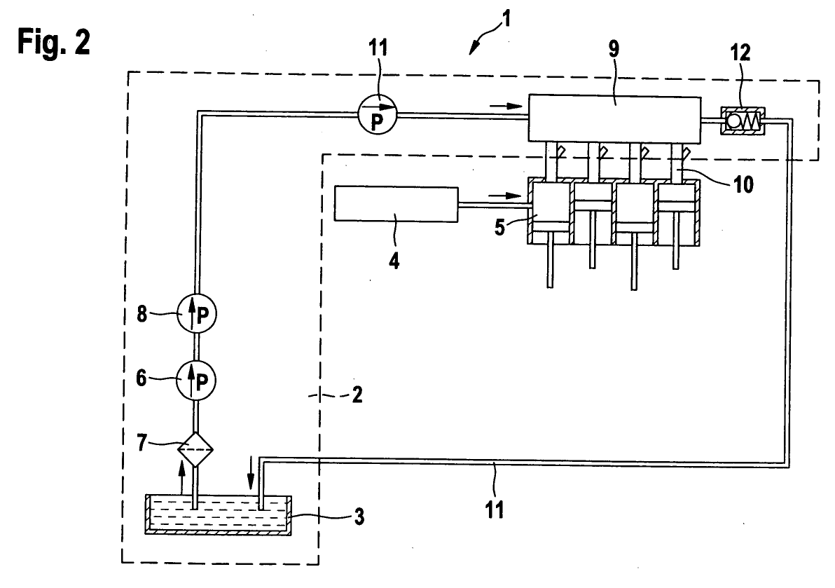

FIG. 2 shows a second specific embodiment of an internal combustion engine 1 according to the present invention. In this specific embodiment, the fuel transported by fuel supply system 2 is not injected into an intake manifold 4, but directly into combustion chambers 5 of internal combustion engine 1. Only air travels into combustion chambers 5 via intake manifold 4. Such direct-injection gasoline engines operate at a considerably higher operating pressure than internal combustion engines having manifold injection (cf. FIG. 1). In the case of direct-injection gasoline engines, this increased operating pressure is approximately 120 to 150 bar and, in the case of direct injection diesel engines, even 1300 to 1700 bar.

In order that such a higher operating pressure may be reached in fuel reservoir 9, a high-pressure pump 11, which is preferably mechanically driven and transports the fuel delivered by electric fuel pumps 6, 8, to fuel reservoir 9 at high-pressure, is provided in addition to the two electric fuel pumps 6, 8. A return line 11 leads from fuel reservoir 9 back into fuel tank 3, a pressure-relief valve 12 being situated in return line 11. High-pressure pump 11 is preferably mechanically driven by a camshaft of internal combustion engine 1 (not shown). High-pressure pump 11 is positioned downstream from the two electric fuel pumps 6, 8 in the direction of flow. Connecting two or more electric fuel pumps 6, 8 in series also has the above-mentioned advantages in the case of direct-injection gasoline engines 1 having an additional high-pressure pump 11 positioned in the fuel path.

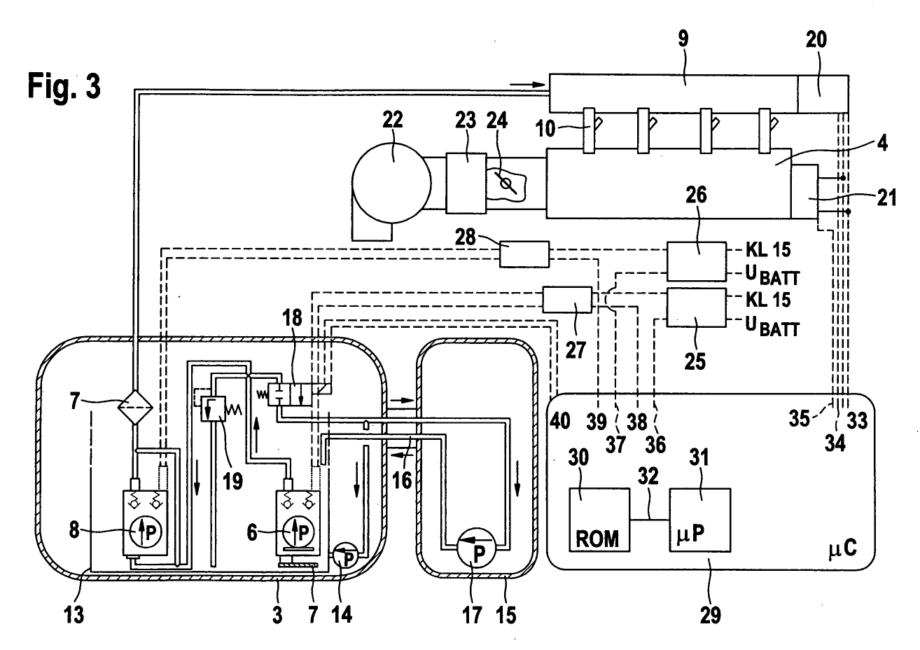

Fuel supply system 2 from FIG. 1 for an internal combustion engine 1 having manifold injection is shown in detail in FIG. 3. Electric fuel pumps 6, 8 are both situated in fuel tank 3. Stated more precisely, the two electric fuel pumps 6, 8 are combined to form a module to be built into fuel tank 3. Electric fuel pumps 6, 8 are situated in a fuel trough 13 in fuel tank 3. This ensures that sufficient fuel is always available for induction, even when the surface of the fuel in fuel tank 3 of electric fuel pump 6 is inclined (e.g. when the vehicle is inclined, or in the case of transverse or longitudinal vehicle acceleration). Sucking jet pumps, of which one is exemplarily represented by reference numeral 14 in FIG. 3, ensure that regardless of the position of the fuel surface in fuel tank 3 in fuel trough 13, a sufficient amount of fuel is always available as long as fuel is still present in fuel tank 3.

Reference numeral 15 denotes a saddle tank, which is spatially separated from fuel tank 3 by, for example, a drive-shaft tunnel and only connected to fuel tank 3 by fuel lines 16. Fuel is exchanged between fuel tank 3 and saddle tank 15 via one or more additional sucking jet pumps, of which one is exemplarily represented in FIG. 3 and referred to by reference numeral 17. The flow of fuel from fuel tank 3 into saddle tank 15 via one of connecting lines 16 may be varied by an electrically controllable valve 18. Using a pressure-relief valve 19, the pressure level of the fuel delivered by first electric fuel pump 6 is kept at an essentially constant value.

A pressure sensor 20 is provided at fuel reservoir 9, in order to measure the operating pressure prevailing in fuel reservoir 9. A pressure sensor 21 is provided at intake manifold 4 of internal combustion engine 1, in order to measure the intake-manifold pressure. An optional means of forced induction 22 (for example, an electrically or mechanically powered turbocharger, supercharger, or the like), an air-mass flow sensor 23, and a throttle valve 24 are situated in an air-intake tube of internal combustion engine, upstream from intake manifold 4 in the direction of flow. A relay for electric fuel pump 6 is denoted by reference numeral 25. A voltage supply U_{Batt} and a switching signal Kl15 (terminal 15) from an on-off switch (e.g. of an ignition key or a switch-on/switch-off button) for internal combustion engine 1 are applied to relay 25. Electric switching devices or control units for signal conversion, signal amplification, and control of electric fuel pumps 6, 8 are denoted by reference numerals 27 and 28.

Reference numeral 29 refers to a control unit for internal combustion engine 1, which may take the form of a microcontroller. Control unit 29 includes a memory element 30, which takes the form of, e.g. a flash memory. A computer program, which may be run on a computing element 31 of control unit 29, is stored in memory element 30. Computing element 31 takes the form of, e.g. a microprocessor. To execute the computer program, it is transmitted either in sections, e.g. as instructed, or in its entirety by memory element 30 to computing element 31 via a data connection 32. During the execution of the computer program on computing element 31, ascertained results or, other data may be transmitted in the reverse direction, from computing element 31 via data connection 32 to memory element 30, where they are stored, for example, for later, further processing.

The execution of the computer program on computing element 31 allows control signals to be generated for different components of fuel supply system 2 according to the present invention. In this context, different control strategies for operating fuel supply system 2 may be followed. Among other things, a signal 33 for supplying voltage to pressure sensors 20, 21 is generated in control unit 29 and transmitted to them. Pressure signal 34 acquired by pressure sensor 20 and pressure signal 35 acquired by pressure sensor 21 are transmitted to control unit 29. Signals for controlling relays 25, 26 of electric fuel pumps 6, 8 are denoted by reference numerals 36 and 37.

Reference numeral 38 refers to a control signal for first electrical switching device or control unit 27 of first electric fuel pump 6. Control signal 38 is, for example, an analog or a pulse-width-modulated signal. Reference numeral 39 refers to a control signal for second electrical switching device or control unit 28 for controlling second electric fuel pump 8. Finally, reference numeral 40 designates a signal for controlling electrical control valve 18.

Signal 39 is a function of different parameters of internal combustion engine 1, the motor vehicle, and/or the surroundings, such as of the speed of internal combustion engine 1 and the surrounding temperature. Electrical switching devices or control units 27, 28 convert control signals 38, 39 of superordinate electronic engine control unit 29 to proportional signals for operating electric fuel pumps 6, 8. In this context, first electric fuel pump 6 is preferably driven at the maximum feed rate. Second electric fuel pump 8 is preferably controlled in a variable manner according to demand. The demand-responsive control of the fuel amount and the fuel pressure of second electric fuel pump 8 is adjusted by electronic engine control unit 29 to the operating state of first electric fuel pump 6 and varied as a function of this. Control signals 38, 39 of electronic engine control unit 29 may be analog or pulse-width-modulated signals. The control signals generated by switching devices or control units 27, 28 for controlling electric fuel pumps 6, 8 are preferably pulse-width-modulated signals.

Depending on how second electric fuel pump 8 is controlled, it delivers more or less fuel to fuel reservoir 9, whereby the operating pressure prevailing in fuel reservoir 9 increases or (if fuel is injected into intake manifold 4 of internal combustion engine and, however, the delivered-fuel quantity of second electric fuel pump 8 is less,) decreases. In this specific embodiment, the control means for implementing the demand-responsive adjustment of the fuel delivered by second electric fuel pump 8 to a specifiable level of operating pressure therefore include control unit 29 having the control program running on computing element 31, as well as switching devices or control units 27, 28 for controlling electric fuel pumps 6, 8.

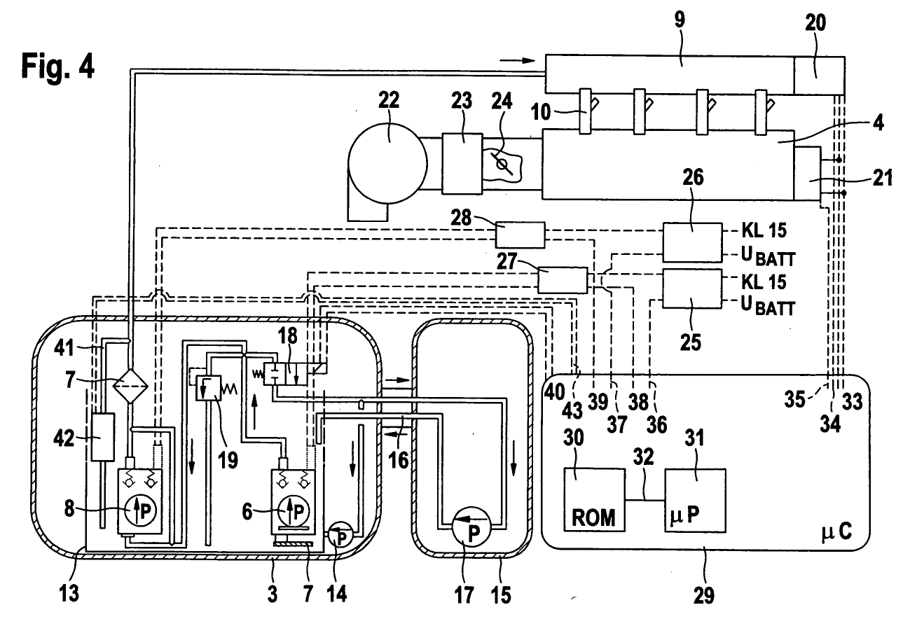

A second preferred embodiment of fuel supply system 2 from FIG. 1 is shown in detail in FIG. 4. Fuel supply system 2 represented in FIG. 4 differs from the one represented in FIG. 3 in that, in particular, a return line 41 having a control element 42 positioned in it branches off downstream from second electric fuel pump 8, fuel conveyed by second electric fuel pump 8 being able to be directed through the return line and back into fuel tank 3. Control element 42 is electrically controllable and is activated by a control signal 43 generated by control unit 29. The flow of fuel through additional return line 41 may be varied with the aid of control element 42. In this specific embodiment, the control means for implementing the demand-responsive adjustment of the fuel delivered by second electric fuel pump 8 to a specifiable level of operating pressure therefore include control unit 29 having the control program running on computing element 31, as well as control element 42.

Control element 42 may take the form of an electric pulse valve, which may be a solenoid valve and may be synchronously triggered in such a manner, that a flow rate through return line 41 is provided that is proportional to the timing, and therefore, variable, demand-controlled operation of second electric fuel pump 8 is rendered possible.

Control element 42 may alternatively take the form of a proportionally opening, electric fuel-quantity control valve, which is energized or timed with the aid of control signal 43, so that it proportionally opens as a function of the current flow through it or the frequency of the timing. In this manner, a cross-section of the fuel-delivery control valve proportional to the current flow or the timing is unblocked and a proportional flow rate corresponding to the unblocked cross-section is provided.

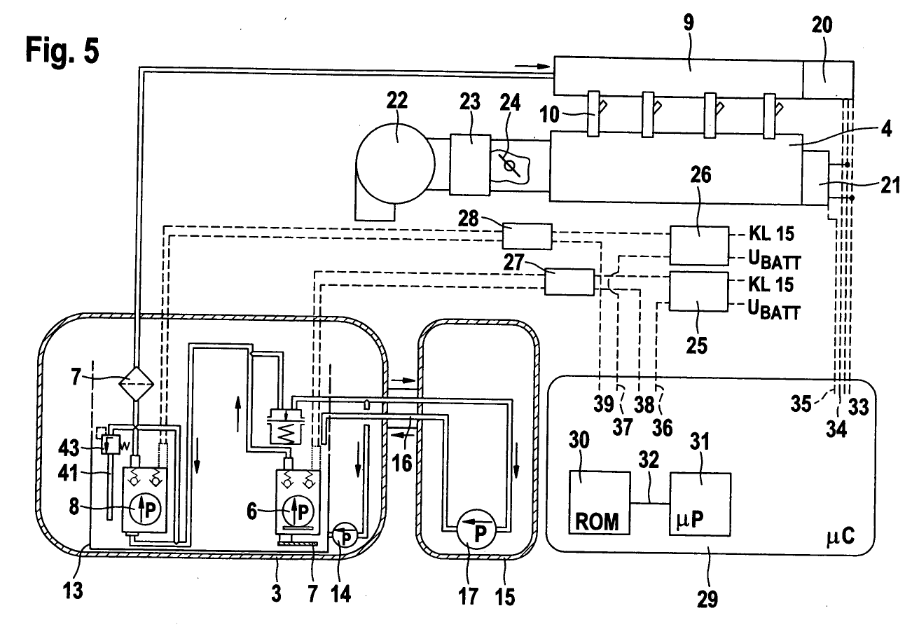

A third preferred embodiment of fuel supply system 2 from FIG. 1 is shown in detail in FIG. 5. In this exemplary embodiment, control element 42 takes the form of a mechanical pressure regulator 43.

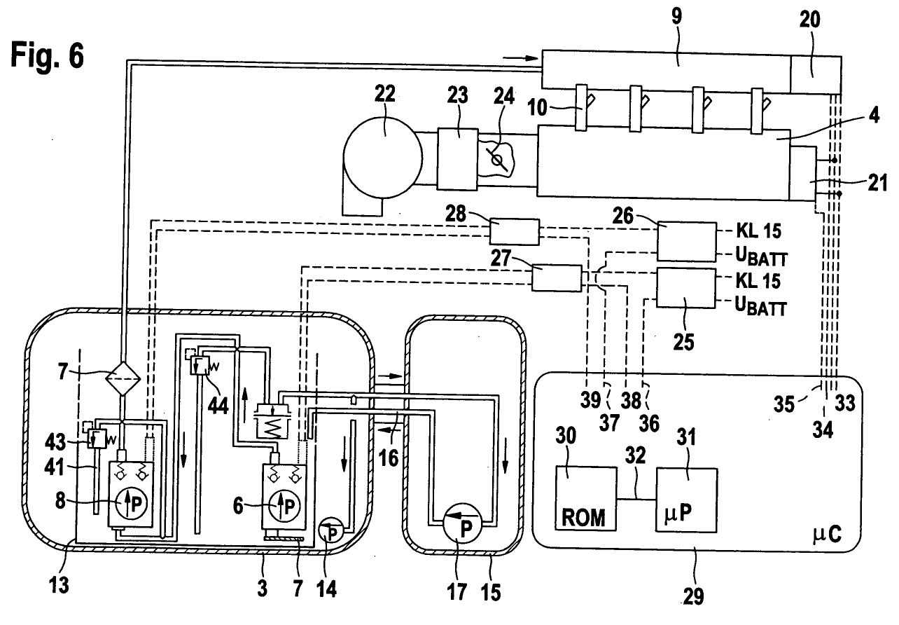

A fourth preferred embodiment of fuel supply system 2 from FIG. 1 is shown in detail in FIG. 6. In this exemplary embodiment, control element 42 takes the form of a mechanical pressure regulator 43. In addition, first electric fuel pump 6 is likewise assigned a mechanical pressure regulator 44, which adjusts the pressure on the pressure side of first electric fuel pump 6 to a pressure level below the operating pressure. Therefore, each of the two electric fuel pumps 6, 8 are adjusted to a separate pressure level by mechanical pressure regulators 43, 44.

In the exemplary embodiments represented in FIGS. 5 and 6, the two electric fuel pumps 6, 8, fuel filters 7, and the, or each, mechanical pressure regulator(s) 43 are preferably combined to form a module, which is designed to be installed in fuel tank 3. In the specific embodiments of fuel supply system 2 according to the present invention, which are represented in FIGS. 3 through 6, it is also possible for electric fuel pumps 6, 8 to not be controlled by control unit 29. The operating pressure is then set and controlled by control element 42 or mechanical pressure regulator 43 alone. In this context, control element 42 may be mechanically controlled or, for example, electrically controlled by control unit 29.

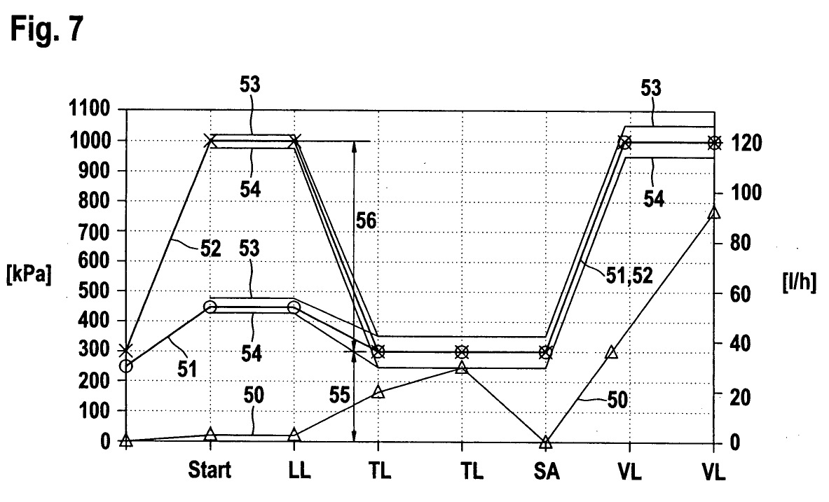

A control strategy for fuel supply system 2 of the present invention is shown in FIG. 7. Different operating states of internal combustion engine 1 of the motor vehicle are plotted on the x-axis. The operating pressure in kPa (100 kPa correspond to 1 bar) prevailing in fuel reservoir 9 is plotted on the left side of the y axis. The demand of internal combustion engine 1 for fuel in l/h is plotted on the right side of the y axis. In the graph in FIG. 7, the current fuel demand in the different operating states is graphically illustrated by a line 50. The two upper lines 51, 52 in the graph represent the operating pressure prevailing in fuel reservoir 9 at the current operating point, lower line 51 being valid for a warm internal combustion engine 1 and upper line 52 being valid for a cold internal combustion engine 1. In the case of a warm and a cold internal combustion engine 1, lines 53 and 54 above and below the operating-pressure curve, respectively, approximately limit the region in which the actual operating pressure may move due to pulsations in fuel supply system 2. Reference numeral 55 indicates the pressure range, which may be attained by first electric fuel pump 6. The pressure range, which goes beyond it and is attained by second electric fuel pump 8, is denoted by reference numeral 56.

According to the control strategy represented in FIG. 7, an operating pressure of 2.5 bar (in the case of a warm internal combustion engine 1) and 3.0 bar (in the case of a cold internal combustion engine 1) is present in fuel reservoir 9 when the vehicle stopped. This pressure level may be attained by first electric fuel pump 6 alone. However, during a starting phase of internal combustion engine 1, the operating pressure is already increased to a pressure level of approximately 4.5 bar (for a warm engine 1) or 10 bar (for a cold engine 1). Second electric fuel pump 8 is switched on to increase the operating pressure to these pressure values. During a starting phase of internal combustion engine 1, internal combustion engine 1 requires an approximately constant amount of fuel while passing over into idling operation (LL). Accordingly, the pressure level of 4.5 bar or 10 bar is also maintained. During the transition from idling operation to part-throttle operation (TL), the fuel demand of internal combustion engine 1 increases. Nevertheless, the operating pressure decreases to a value of approximately 3 bar, curves 21, 22 of the operating pressure slowly approaching each other as a function of the surrounding temperature and the operating time of internal combustion engine 1, since initially cold internal combustion engine 1 warms up with time.

During the part-throttle operation of the internal combustion engine, the operating pressure in fuel reservoir 9 is kept at an essentially constant level, regardless of the fuel demand of internal combustion engine 1. This pressure level may be attained by first electric fuel pump 6 alone, so that second electric fuel pump 8 may be switched off during this time. However, as soon as internal combustion engine 1 is operated in full-throttle region (VL) and the fuel-quantity demand increases, then the operating pressure steeply rises to values in the range of approximately 10 bar. To increase the operating pressure to this pressure level, second electric fuel pump 8 must be switched on again.

The increase in the operating pressure during full-throttle operation allows a higher fuel flow rate to be provided or the nominal flow rate of an injector 10 at standard pressure to be reduced. This results in improved mixture preparation [carburetion] and, consequently, a reduced hydrocarbon (HC) output.

Fuel supply system 2 of the present invention is suitable, in particular, for improving the running smoothness and reducing the fuel consumption and the pollutant emissions. In the case of manifold-injection engines, it is particularly suitable for implementing low-emissions designs for future exhaust-gas legislation.

1. A fuel supply system for an internal combustion engine (1) for delivering fuel from a fuel tank (3) into at least one intake manifold (4) or at least one combustion chamber of the internal combustion engine (1), comprising at least two fuel pumps (6, 8; 11) connected in series, wherein at least two of the fuel pumps (6, 8; 11) of the fuel supply system (2) take the form of electric fuel pumps (6, 8).

2. The fuel supply system (2) as recited in claim 1, wherein the fuel supply system (2) has at least one mechanically driven, high-pressure pump (11) situated hydraulically nearer to the internal combustion engine (1) than the electric fuel pumps (6, 8).

3. The fuel supply system (2) as recited in claim 1, wherein the fuel pumps (6, 8) of the fuel supply system (2) are exclusively electric fuel pumps (6, 8).

4. The fuel supply system (2) as recited in claim 2, wherein the fuel supply system (2) has exactly two electric fuel pumps (6, 8) connected in series.

5. The fuel supply system (2) as recited in claim 1, wherein the fuel supply system (2) has control means for adjusting the fuel delivered by the electric fuel pump (8) situated hydraulically nearest to the internal combustion engine (1), to a specifiable pressure level.

6. The fuel supply system (2) as recited in claim 5, wherein the control means adjust the fuel delivered by the electric fuel pump (8) situated hydraulically nearest to the internal combustion engine (1), to the specifiable pressure level in a demand-responsive manner.

7. The fuel supply system (2) as recited in claim 5, wherein the specifiable pressure level is variable.

8. The fuel supply system (2) as recited in claim 5, wherein the control means have a control unit (29) for switching on and off the electric fuel pump (8) situated hydraulically nearest to the internal combustion engine (1) or for varying speed of this electric fuel pump (8).

9. The fuel supply system (2) as recited in claim 5, wherein the control means have a controllable control element (42), which is situated in a return line (41) from a pressure side of the electric fuel pump (8) situated hydraulically nearest to the internal combustion engine (1), to the fuel tank (3), or to the suction side of this electric fuel pump (8).

10. The fuel supply system (2) as recited in claim 9, wherein the control element (42) is electrically controllable, and the control means have a control unit (29) for controlling the control element (42).

11. The fuel supply system (2) as recited in claim 10, wherein the control element (42) takes the form of a pulse valve.

12. The fuel supply system (2) as recited in claim 10, wherein the control element (42) takes the form of a proportional fuel-quantity control valve.

13. The fuel supply system (2) as recited in claim 9, wherein the control element (42) takes the form of a mechanical pressure regulator (43) for adjusting the pressure prevailing on the pressure side of the electric fuel pump (8) situated hydraulically nearest to the internal combustion engine, to the specifiable pressure level.

14. The fuel supply system (2) as recited in claim 13, wherein each of the electric fuel pumps (6, 8) of the fuel supply system (2) is assigned a mechanical pressure regulator (43, 44), the pressure regulators (43, 44) each being situated in a return line (41) from a pressure side of one of the electric fuel pumps (6, 8) to the fuel tank (3), or to the suction side of this electric fuel pump (6, 8), and the pressure regulators (43, 44) adjusting the pressures prevailing on the pressure sides of the electric fuel pumps (6, 8) to different pressure levels.

15. The fuel supply system (2) as recited in claim 14, wherein the pressure levels increase from the first electric fuel pump (6) to the electric fuel pump (8) positioned nearest to the internal combustion engine.

16. The fuel supply system (2) as recited in claim 13, wherein all of the electric fuel pumps (6, 8), filters (7), control element (42), and pressure regulators (43, 44) are situated in the fuel tank (3) or in a module to be built into the fuel tank (3).

17. An internal combustion engine (1) for a motor vehicle, having a fuel supply system (2) for delivering fuel from a fuel tank (3) into at least one intake manifold (4) or at least one combustion chamber (5) of the internal combustion engine (1), the fuel supply system (2) including at least two fuel pumps (6, 8; 11) connected in series, wherein the fuel supply system (2) is formed as recited in claim 1.
